(19) United States
(12) Patent Application Publication
(10) Pub. No.: US 2024/0386250 A1
(43) Pub. Date: Nov. 21, 2024

(54) VERIFICATION OF AGENT OUTPUT THROUGH ADVERSARIAL DEBATE

(71) Applicant: DeepMind Technologies Limited, London (GB)

(72) Inventor: Jonah Isaac Brown-Cohen, London (GB)

(21) Appl. No.: 18/665,702

(22) Filed: May 16, 2024

Related U.S. Application Data
(60) Provisional application No. 63/502,793, filed on May 17, 2023.

(51) Int. Cl. G06N 3/047; G06N 3/045; G06N 3/092

(52) U.S. Cl. CPC G06N 3/047; G06N 3/045; G06N 3/092

(57) ABSTRACT

A computer-implemented method of generating for an input a corresponding verification output that takes a first value or a second value, where the verification output taking the first value is statistically correlated with an agent output provided by a first computer-implemented agent in response to the input being valid for the input and the verification output taking the second value is statistically correlated with the agent output provided by the first computer-implemented agent in response to the input not being valid for the input.

### CROSS-REFERENCE TO RELATED APPLICATIONS

This application claims priority to U.S. Provisional Application No. 63/502,793, filed on May 17, 2023. The disclosure of the prior application is considered part of and is incorporated by reference in the disclosure of this application.

### BACKGROUND

This specification relates to methods for verifying whether outputs generated by computer-implemented agents are valid. The methods can be used during training computer-implemented agents to produce outputs that are valid. Outputs that are valid may be outputs that have a desired effect, such as when used to control real-world systems. The methods can be used for evaluating outputs of computer-implemented agents to determine whether to use the outputs to control real-world systems.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes methods, implemented as computer programs on one or more computers in one or more locations, that enable a user to obtain a verification output indicating whether an agent output generated by a computer-implemented agent, in response to an input, is valid or not. In implementations, the method can generate the verification output by the computer-implemented agent providing a justification for the agent output that is examined by a second computer-implemented agent in a “debate” protocol. The output of the debate may be examined to determine if the agent output is valid. Some implementations of the system can be used to determine whether instructions included in an agent output configured to perform a real-world task will result the successful performance of the real-world task. The real-world task may require control of a mechanical or computer system or network, e.g. a robot, or a manufacturing plant, or items of equipment such as heating or cooling equipment, or a computer system or network. Some implementations of the system may be configured for verification of an output generated by a computer-implemented agent configured to generate an agent output can be used for natural language control of a task in a real-world environment, in which case the verification output obtained may be used to control a task performed e.g. by a mechanical or computer system.

There is described herein a method, and a corresponding system, implemented by one or more computers, in particular for generating for an input a corresponding verification output that takes a first value or a second value, where the verification output taking the first value is statistically correlated with an agent output provided by a first computer-implemented agent in response to the input being valid for the input.

In one example implementation described herein, there is provided a computer-implemented method of generating for an input a corresponding verification output that takes a first value or a second value, where the verification output taking the first value is statistically correlated with an agent output provided by a first computer-implemented agent in response to the input being valid for the input and the verification output taking the second value is statistically correlated with the agent output provided by the first computer-implemented agent in response to the input not being valid for the input. The term “statistically correlated,” as used herein, indicates the relationship between the verification output, indicating the validity of an agent output, and the actual validity of that agent output as determined by the stochastic oracle. The statistical correlation in this context indicates that the verification output reliably predicts the true validity of the agent output for the input, as would be assessed by, for example, the stochastic oracle (e.g. a group of human users or other source of answers). This correlation may be determined by, for example, comparing the verification output to the probabilistic judgments provided by the stochastic oracle for individual steps within the agent's computation.

The verifying comprises employing a second computer-implemented agent, at least one of the first and second computer-implemented agents acting according to respective ones of a first and second protocol to verify, for a justification composed of a set of logical steps comprising one or more probabilistic agent outputs, whether the one or more probabilistic agent outputs correlate with probabilistic oracle values that would be output by a stochastic oracle. A stochastic oracle is a source of information that produces probabilistic outputs in response to queries. These outputs represent the likelihood of different possible outcomes or the confidence level associated with a specific answer or decision. The stochastic oracle can take various forms depending on the application. For instance, it could model inherent uncertainty or randomness in a system or process, providing probabilistic assessments for specific aspects of that system. A stochastic oracle may represent human evaluation or real-world observations, providing probabilistic outputs for queries about individual steps within a computation. This could reflect the likelihood that, for example, a human judge, would deem a particular step correct or valid. In some example implementations, a stochastic oracle may be implemented as a system that obtains or models human judgment on the correctness of individual steps in a computation proposed by an Al agent. Its probabilistic outputs reflect the likelihood that a human expert would endorse the agent's reasoning and actions for each step.

The first protocol comprises, for each of successive ones of the set of logical steps, generating a corresponding probabilistic agent output which is statistically correlated with a corresponding probabilistic oracle value. The second protocol comprises for each of the successive ones of the logical steps: determining whether the first computer-implemented agent has generated the probabilistic agent output in accordance with the first protocol; responsive to determining that the first computer-implemented agent has not generated the probabilistic agent output in accordance with the first protocol, generating a warning. The verifying further comprises a verification protocol. The verification protocol comprises, if no warning is generated by the second computer-implemented agent, generating a verification output indicating that the probabilistic agent output is valid. The verification protocol further comprises, if the second computer-implemented agent generates a warning for one of the successive probabilistic logical steps: sampling the stochastic oracle in respect of the probabilistic logical step; generating the verification output having the first value when a correlation of the sampled results with the probabilistic agent output meets a first correlation criteria; and generating the second verification output having the second value when the correlation of the sampled results with the probabilistic agent output does not meet the first correlation criteria.

The first computer-implemented agent and the second computer-implemented agent may be respective instances of the same computer-implemented agent.

Sampling the stochastic oracle may comprise: outputting a plurality of oracle queries and receiving a plurality of corresponding oracle answers; and determining a sample mean of the oracle answers. Determining a correlation of the sampled results with the probabilistic agent output may comprise determining a correlation between the sample mean and the probabilistic agent output.

Generating a probabilistic agent output which is statistically correlated with the corresponding probabilistic oracle value may comprise outputting a probability for the logical step that is equal to a probability that would be generated by the stochastic oracle for the logical step.

The probability for the logical step may indicate a probability that a part of the agent output corresponding to the logical step takes a particular value.

For a logical step t the probability for the logical step may be given by

$${\hat{p}}_{t} = \frac{{\hat{c}}_{t}}{d} ,$$

where ĉₜ={0, . . . , d}, d is a positive integer. Alternatively, for a logical step t the probability for the logical step may be given by \hat{p}ₜ=∈[0,1], which is supposed to be equal to [symbol] [yₜ=1|yᵢ₍ₜ₎=a_{I(t)}]. d may equal [150K], where the oracle 115 is K-Lipschitz. K may be K=0(\sqrt{T}). K may be a constant independent of T. For example K may be K=0(1).

Generating first protocol output may comprise: the first computer-implemented agent obtaining a first query input from an independent copy of the second computer-implemented agent; and the second computer-implemented agent obtaining a second query input from an independent copy of the first computer-implemented agent.

Generating the first protocol output may comprise determining a single query input based on the first and second query inputs; and setting the first protocol output based on whether the probability for the logical step is greater than the combined single query input.

The first computer-implemented agent obtaining a first query input from an independent copy of the second computer-implemented agent may comprise querying the independent copy of the second computer-implemented agent for a random integer value sampled uniformly from {0, . . . ,d}; and the second computer-implemented agent obtaining a second query input from an independent copy of the first computer-implemented agent may comprise querying the independent copy of the first computer-implemented agent for a random integer value sampled uniformly from {0, . . . ,d}.

Determining, by the second computer-implemented agent, whether the first computer-implemented agent has generated the probabilistic agent output in accordance with the first protocol may comprise sampling the stochastic oracle in respect of the probabilistic logical step.

The first and second computer-implemented agents may be sequence models. The first and second computer-implemented agents may be language models. The first and second computer-implemented agents may be multi-modal sequence models

The computer-implemented method may further comprise receiving and providing the input to the first computer-implemented agent to generate the agent output.

The verification protocol may be performed by a verifier. The verifier may be computationally limited compared to the first and second computer-implemented agents. The verifier may be a machine-learned model trained on sparse human judgements.

The stochastic oracle may comprise one or more human agents.

The stochastic oracle may comprise one or more sensors measuring a real-world environment.

The input may indicate a security breach in a computing device or computer-network. The agent output may comprise computer program code for execution by the device or computer network. The verification output having the first value may indicate that the output is configured to cause one or more computers to perform one or more actions configured to address the security breach.

The input may comprise input data derived from one or more sensors, each sensor input indicating one or more properties of one or more physical objects in a real-word environment. The input may further comprise a request to output one or more instructions to complete a task including an action on or using the one or more physical objects. The agent output may comprise one or more instructions for execution by a real-world agent interacting with the environment. The verification output having the first value may indicate that execution of the one or more instructions by the real-world agent will result in completion of the action on or using the one or more physical objects. The computer-implemented method may further comprise selectively controlling the real-world agent to perform action when the verification output has the first value and not controlling the real-world agent to perform the action when the verification output has the second value.

The verification output having the first value may indicate that completion of the action meets a safety criteria.

The verification output may be one of a plurality of verification outputs obtained by performing the verifying a plurality of times, and the method may further comprise generating a final verification output based on the plurality of verification outputs.

In another implementation described herein, there is provided a method of training a computer-implemented agent, comprising performing, during training of the computer-implemented agent, the method of generating a verification output set out above and updating parameters of the computer-implemented agent based on a loss function comprising one or more terms configured to penalise an agent outputs that result in a verification output indicating that the agent output is not valid.

In another implementation described herein, there is provided a computer-implemented method, comprising: receiving, from a first computer-implemented agent, a first agent output responsive to an input, the input indicating one or more tasks to be performed; verifying, in accordance with the method of generating a verification output set out above, whether the first agent output generated by the first computer-implemented agent in response to the input is valid.

The computer-implemented method may further comprise in response to verifying that the first agent output is valid, causing the task to be performed in accordance with the first agent output.

The computer-implemented method may further comprise in response to determining that the first agent output is not valid, obtaining, from the first computer-implemented agent and/or a further computer-implemented agent, a second agent output responsive to the input.

In another implementation described herein, there is provided one or more computer storage media storing instructions that when executed by one or more computers cause the one or more computers to perform the operations of the method(s) set out above.

In another implementation described herein, there is provided a system comprising: one or more computers; and one or more storage devices communicatively coupled to the one or more computers, wherein the one or more storage devices store instructions that, when executed by the one or more computers, cause the one or more computers to perform operations of the method(s) set out above.

The subject matter described in this specification can be implemented in particular embodiments so as to realize one or more of the following advantages.

The techniques described herein may be used during training of a computer-implemented agent in order to reduce the incidence with which a computer-implemented agent outputs agent outputs that are invalid.

The techniques described herein enable an agent output to be processed to provide an indication as to whether the agent output is valid. Complex and extensive computations, which may be described in natural language, can be verified by querying an oracle for only few, or even a single, step(s) of such a computation. This enables a user, for example a human user, to verify the output of the model in a computationally efficient manner. In particular, the verification techniques described herein provide a protocol for a doubly-efficient debate where a computer-implemented agent outputting a valid output can demonstrate validity in polynomial time, even when a “dishonest” computer-implemented agent is allowed unbounded computation. The approaches described above enable a computer-implemented agent to learn by “self-play”, that is by “talking to”, i.e. conducting a dialogue with, itself with very limited external feedback.

Where machine learned models are used to control real-world systems and processes, such as control of mechanical agents to perform mechanical tasks, incorrect or invalid outputs from the machine learned model can result in failure to correctly perform the task. This can lead to wasted resources, for example where consumables, energy and time are used during an unsuccessful attempt to perform the task, along with those used in remedial actions. Further, control of real-world agents may have safety consequences. For example, imprecise or erroneous control of autonomous vehicles or of industrial robots may cause damage to humans, animals or equipment. The techniques described herein therefore enable users to efficiently ensure that machine learned models are trained to generate valid outputs or to evaluate outputs before use to help to ensure that the task will be performed correctly and/or safely.

The ability to demonstrate a valid output with few or a single step allows for at least part of the verification to be performed by devices having limited computing resources such as processor and memory resources.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

Embodiments of the invention will now be described, by way of example only, with reference to the accompanying schematic drawings, in which:

FIG. 1 shows an example system configured to perform a computer-implemented method;

FIG. 2 is a flow chart of an example computer-implemented method of generating for an input a corresponding verification output;

FIG. 3 is a flow chart of an example method of training a computer-implemented agent;

FIG. 4 is a flow chart of an example computer-implemented method; and

FIG. 5 shows an example system.

Like reference numbers and designations in the various drawings indicate like elements.

### DETAILED DESCRIPTION

This specification relates to methods, implemented as computer programs on one or more computers in one or more locations, and systems that enable a user to obtain a verification output indicating whether an agent output generated by a computer-implemented agent, in response to an input, is valid or not. In implementations, the methods and/or systems can generate the verification output by the computer-implemented agent providing a justification for the agent output that is examined by a second computer-implemented agent in a “debate” protocol. The output of the debate may be examined to determine if the agent output is valid. The methods and/or systems can be used during training computer-implemented agents to produce outputs that are valid. Outputs that are valid may be outputs that have a desired effect, such as when used to control real-world systems.

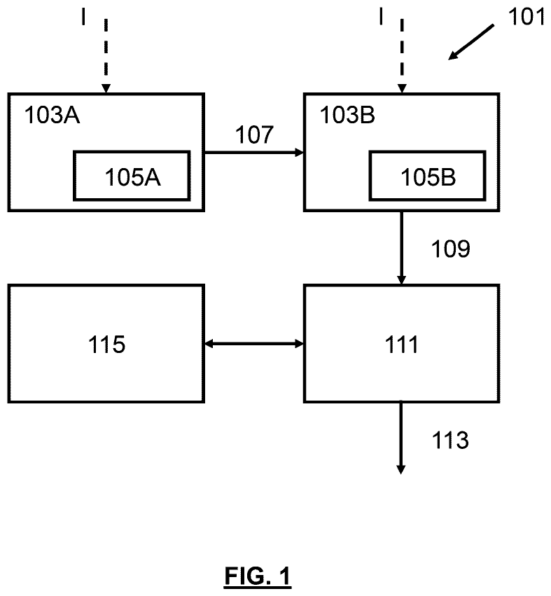

FIG. 1 shows an example architecture of a system 101. The system 101 is an example of a system implemented as computer programs on one or more computers in one or more locations, in which the systems, components, and techniques described below can be implemented.

The system 101 of FIG. 1 comprises a first computer-implemented agent 103A. The first computer-implemented agent 103A is configured to act according to a first protocol 105A. The first protocol 105A is configured to cause the first computer-implemented agent 103 to generate, in response to an input I, a corresponding probabilistic agent output 107. When the first computer-implemented agent 103A is acting in accordance with the first protocol 105A, the probabilistic agent output 107 should be statistically correlated with a corresponding probabilistic oracle value for each of successive ones of a set of logical steps. That is, for each logical step, the probabilistic agent output 107 be a good proxy for the output that would be provided by the probabilistic oracle value that would be provided for the logical step. Given that the outputs are probabilistic, any particular agent output 107 may not exactly match any particular oracle output for the same step, but the outputs of each should be statistically correlated such that as the inputs I change, the outputs of both the agent and the oracle change in predictable ways. When the first computer-implemented agent 103A is not acting in accordance with the first protocol 105A, the probabilistic agent output 107 may not be statistically correlated with a corresponding probabilistic oracle value for each of successive ones of a set of logical steps.

The system 101 further comprises a second computer-implemented agent 103B. The second computer-implemented agent 103B is configured to act according to a second protocol 105B. The second protocol 105B is configured to cause the second computer-implemented agent 103B to determine whether the first computer-implemented agent 103A has generated the probabilistic agent output 107 in accordance with the first protocol 105A. When the second computer-implemented agent 103B is acting in accordance with the second protocol 105B, the second computer-implemented agent 103B should generate a warning 109, responsive to determining that the first computer-implemented agent 103A has not generated the probabilistic agent output 107 in accordance with the first protocol 105A (true positive). When the second computer-implemented agent 103B is acting in accordance with the second protocol 105B, the second computer-implemented agent 103B should not generate a warning 109, responsive to determining that the first computer-implemented agent 103A has generated the probabilistic agent output 107 in accordance with the first protocol 105A (true negative). When the second computer-implemented agent 103B is not acting in accordance with the second protocol 105B, the second computer-implemented agent 103B may not generate a warning 109 when the first computer-implemented agent 103A has not generated the probabilistic agent output 107 in accordance with the first protocol 105A (false negative). When the second computer-implemented agent 103B is not acting in accordance with the second protocol 105B, the second computer-implemented agent 103B may generate a warning 109 when the first computer-implemented agent 103A has generated the probabilistic agent output 107 in accordance with the first protocol 105A (false positive).

The first computer-implemented agent 103A and/or the second computer-implemented agent 103B may be configured to receive an input I.

The first computer-implemented agent 103A and the second computer-implemented agent 103B may be respective instances of the same computer-implemented agent. The first and second computer-implemented agents 103A, 103B may share the same architecture, parameters and/or hyperparameters. Alternatively, the first and second computer-implemented agents 103A, 103B may be different agents.

The first and/or second computer-implemented agents 103A, 103B may be sequence models. As will be understood by the skilled person, a sequence model is a machine learning model that receive data indicative of an input sequence and/or outputs sequences of data. For example, either or both of the first and/or second computer-implemented agents 103A, 103B may be models comprising one or more self-attention layers, such as Transformer-based so called Large Language Models (LLMs). The first and/or second computer-implemented agents 103A, 103B may be language generation neural network. Language generation neural networks typically comprises a sequence-to-sequence model that receives an input sequence of natural language tokens and generates an output sequence of natural language tokens. Typically a natural language token defines a word or wordpiece (e.g. a word segment or morpheme), but it may also define a letter, or multiple words. The tokens may include tokens representing punctuation. In some implementations an output sequence of natural language tokens is generated a word or wordpiece at a time. In general any language generation neural network may be used, e.g. an auto-regressive language generation neural network, or a language generation neural network that does not rely on an auto-regressive model such as a recurrent language generation neural network or a denoising auto-encoder based language model (arXiv:2112.06749). As an example, a language generation neural network as described herein can be a transformer-based language model neural network, in particular an autoregressive transformer-based language model neural network. A transformer neural network may be characterized by having a succession of self-attention neural network layers. The first and/or second computer-implemented agents 103A, 103B may be language models. A language model is similar to a language generation model but may process an input sequence of natural language tokens to generate a vector or scalar output rather than generating an output sequence of natural language tokens.

The first and second computer-implemented agents 103A, 103B may be multi-modal models. For example, the first and second computer implemented agents 103A, 103B may be configured to receive inputs I that include data of a plurality of modalities such as by way of example, language, image, sound and/or other sensor data and/or information relating to an operating state of a system and/or to generate outputs 107 that include data of a plurality of modalities.

The system 101 further comprises a verification protocol 111. The verification protocol 111 is configured to verify whether the first computer-implemented agent 103A is acting in accordance with the first protocol 105A, i.e. whether the first probabilistic agent output 107 is valid. The verification protocol 111 is configured to generate a verification output 113 indicating that the probabilistic agent output 107 is valid if no warning 109 is generated by the second computer-implemented agent 103B.

The system 101 further comprises a stochastic oracle 115. The verification protocol 111 is configured such that if the second computer-implemented agent 103B generates a warning 109 for one of the successive probabilistic logical steps, the verification protocol 111 samples the stochastic oracle 115 in respect of the probabilistic logical step. The verification protocol 111 is further configured to generate the verification output 113 having the first value when a correlation of the sampled results with the probabilistic agent output 107 meets a first correlation criteria. The verification protocol 111 is configured to generate the second verification output 113 having the second value when the correlation of the sampled results with the probabilistic agent output 107 does not meet the first correlation criteria.

The verification output 113 taking the first value is statistically correlated with an agent output 107 provided by a first computer-implemented agent 103A in response to the input I being valid for the input I and the verification output 107 taking the second value is statistically correlated with the agent output 107 provided by the first computer-implemented agent 103A in response to the input I not being valid for the input I.

The skilled person would appreciate that the computer-implemented agents 103A, 103B described in relation to FIG. 1 may be physical and/or logical entities. The skilled person would further appreciate that a single physical entity may be configured to perform the function of one or more logical entities. For example, each of the entities 103A, 103B may be implemented as computer programs on one or more computers in one or more locations. The entities may be computer programs operating in one or more physical devices such as mechanical agents, as discussed in more detail below. The verification protocol 111 may implemented as computer program(s) on one or more computers in one or more locations. The stochastic oracle 115 may also be implemented in any of a number of ways. By way of example only, the stochastic oracle 115 may be implemented as a computer program providing an interface to a source of the samples. The source of the samples may be, for example, human agents, historical sensor data, live sensors, or some other source of results.

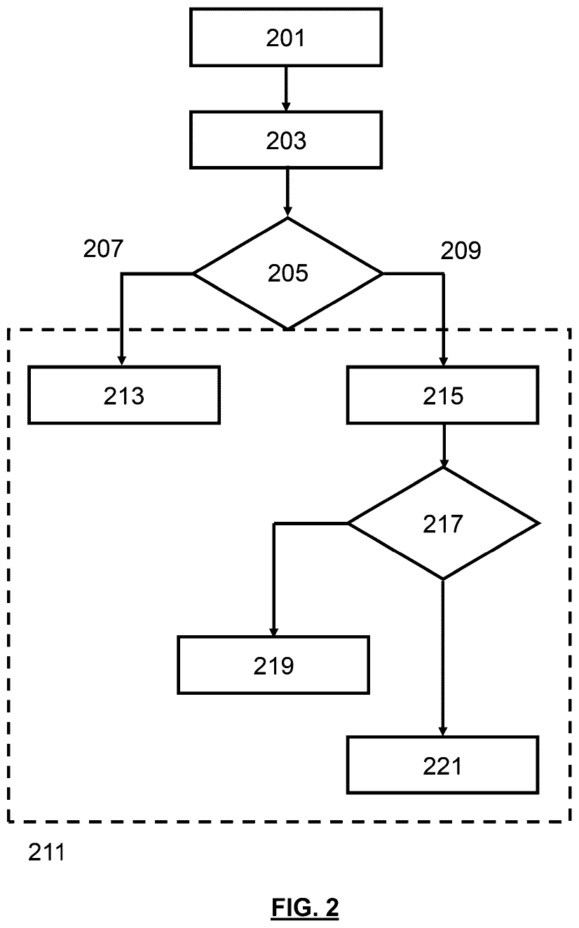

FIG. 2 shows an example computer-implemented method of generating, for an input, a corresponding verification output 113 that takes a first value or a second value, where the verification output 113 taking the first value is statistically correlated with an agent output 107 provided by a first computer-implemented agent 103A in response to the input being valid for the input and the verification output 113 taking the second value is statistically correlated with the agent output 107 provided by the first computer-implemented agent 103A in response to the input not being valid for the input. The computer-implemented method shown in FIG. 2 may be performed by the system of FIG. 1.

The verifying may comprise employing a second computer-implemented agent 103B in order to verify, for a justification composed of a set of logical steps comprising one or more probabilistic agent outputs 107, whether the one or more probabilistic agent outputs 107 correlate with probabilistic oracle values that would be output by a stochastic oracle 115. At least one of the first and second computer-implemented agents 103A, 103B act according to respective ones of a first and second protocol 105A, 105B although it may not be possible to easily or readily determine whether one of the computer-implemented agents 103A, 103B is or is not properly acting according to the respective protocols 103A, 103B.

Each of the probabilistic steps may correspond to a respective part of the agent output 107. For example, where the agent output 107 indicates a sequence of tasks or sub-tasks, each logical step may relate to one of the tasks or sub-tasks.

The probabilistic oracle may comprise, for example, one or more human agents and/or one or more sensors configured to measure a real-world environment, or one or more historical measurements of a real-world environment. More generally, the stochastic oracle may be implementation that can provide a representative ground truth to compare with the agent output 107 to determine if the agent output is correlated with the probabilistic oracle output.

The input I may comprise a request for a mechanical agent to perform a task. The agent output 107 may comprise one or more commands to the mechanical agent. Verifying that the output 107 is valid may comprise verifying that the output 107 will cause the mechanical agent to perform the task. For example, the task may comprise manipulating or measuring one or more real-world objects.

The input I may indicate a problem, such as a security event or security breach relating to a computing device (for example in software running on the computing device or in hardware of the computing device) or a computer-network. For example, the security breach may relate to detection of malware operating on a computing device or the detection of operations being performed by a malicious actor. The agent output 107 may comprise computer program code for execution by the device or computer network. Verifying that the output 107 is valid comprises verifying that the output 107 is configured to cause one or more computers to perform one or more actions configured to address the security breach. The actions may include any appropriate actions but may include changing one or more settings of the computing device or network, removing or installing software on the computing device or components of the computer network, disconnecting one or more computers from the network, etc.

The input I may comprise input data derived from one or more sensors. Each sensor input may indicate one or more properties of one or more physical objects in a real-word environment. The input I may further comprise a request to output one or more instructions to complete an action on or using the one or more physical objects. The agent output 107 may comprise one or more instructions for execution by a real-world agent interacting with the environment. Verifying that the output 107 is valid may comprise verifying that performance of the one or more instructions by the agent will result in completion of the action on or using the one or more physical objects. As described above, either or both of the input I and the agent output 107 may be multi-modal. For example, the input I may comprise one or more images of an environment indicating states and locations of objects within the environment. For example, the environment may be a kitchen and the one or more images may indicate states of ingredients and utensils. The input I may comprise a request to generate instructions to prepare a meal. The output 107 may comprise one or more instructions including, for example, natural language instructions, visual data such as images of video of actions to be performed and/or audio data such as a description of an action to be performed, to instruct the user to prepare the meal. In another example, the environment may include an object (such as a vehicle) on which the user wishes to carry out an action such as repair or servicing. The input I may comprise a request to generate instructions to carry out the action.

In FIG. 2, at block 201 the computer-implemented method comprises employing the second computer-implemented agent 103B to verify, for a justification composed of a set of logical steps comprising one or more probabilistic agent outputs 107, whether the one or more probabilistic agent outputs 107 correlate with probabilistic oracle values that would be output by a stochastic oracle 115.

The method includes receiving the input I and providing the input I to the first computer-implemented agent 103A to generate the agent output 107. For example, the input I may be received from a user of a system implementing the method, which may be a human user or may be a further computer-implemented agent or a software program.

In FIG. 2 block 203 the first computer-implemented agent 103A generates a corresponding probabilistic agent output 107. When the first computer-implemented agent 103A is acting in accordance with the first protocol 105A, the probabilistic agent output 107 should be statistically correlated with a corresponding probabilistic oracle value for each of successive ones of a set of logical steps.

When the first computer-implemented agent 103A is acting in accordance with the first protocol 105A, the probabilistic agent output 107 for a logical step t may be generated based on coordinates any of particular bits of the agent output.

Generating a probabilistic agent output 107 which is statistically correlated with the corresponding probabilistic oracle value may comprise outputting a probability for the logical step that is equal to a probability that would be generated by the probabilistic oracle for the logical step. The probability for the logical step may indicate a probability that a part of the agent output corresponding to the logical step takes a particular value. For example, for T logical steps (or rounds) (which may be taken in lexicographic order), in round t∈[T] the first computer-implemented agent 103A may output a probabilistic agent output 107 indicating a probability that the stochastic oracle 115 would assign a part of the agent output corresponding to the logical step a particular value. For example, for an agent output a and a notional valid agent output y, the probabilistic agent output 107 for the logical step t may be a probability \hat{p}ₜ that is equal a probability Pₜ= [symbol] [yₜ=1|y_{I(t)}=a_{I(t)}], where I(t) is the input at step t. The probability for the logical step t may be given by

$${\hat{p}}_{t} = \frac{{\hat{c}}_{t}}{d} ,$$

where ĉₜ={0, . . . , d}, d is a positive integer. The stochastic oracle 115 may be d-discrete such that for all queries z∈{0,1}^{I} there exists an integer c={0, . . . , d} such that

$$ℙ [ 𝒪 ( z ) = 1 ] = \frac{c}{d} ] .$$

Alternatively, the stochastic oracle 115 may be K-Lipschitz for K= [symbol] (T). For a logical step t the probability for the logical step may be given by \hat{p}ₜ=∈[0,1]. d may equal [150K], where the oracle 115 is K-Lipschitz. K may be K=0(\sqrt{T}). K may be a constant independent of T. For example K may be K=0(1). The stochastic oracle 115 may be K-Lipschitz for K= [symbol] (T). The oracle 115 is K-Lipschitz at source [symbol] if, for any other source [symbol] ,

$$\begin{matrix}sup \\ x\end{matrix} \vert ℙ [ {M}^{𝒪} ( x ) = 1 ] - ℙ [ {M}^{𝒪} ( x ) = 1 ] \vert < K \begin{matrix}sup \\ z\end{matrix} \vert ℙ [ 𝒪 ( z ) = 1 ] - ℙ [ 𝒪 ( z ) = 1 ] \vert$$

In other words, if the oracle 115 is run with any source which assigns similar probabilities to [symbol] , the probability that the oracle 115 outputs ‘1’ (i.e. indicating that an agent output is correct) should change by at most a K factor more than the maximum difference in the oracle probabilities. Every time-T stochastic oracle 115 is K-Lipschitz for K= [symbol] (T).

Generating first protocol 105A output may comprise the first computer-implemented agent 103A obtaining a first query input from an independent copy of the second computer-implemented agent 103B and the second computer-implemented agent 103B obtaining a second query input from an independent copy of the first computer-implemented agent 103A. Obtaining inputs from independent copies of the computer-implemented agents may be achieved by, for example, running multiple copies the same computer-implemented agents. Independent in this context means that the context of one copy of the computer-implemented agent is not available for use by another copy, that is the multiple copies are non-communicating. Alternatively, given that instances of the first and second computer-implemented agents 103A, 103B are already loaded into memory, methods may make efficient use of loaded and cached data by querying the existing instances of the first and second agents with any previous messages in the debate removed from the context. For example, in some implementations, to reduce the computing burden, one or more of the computer-implemented agents 103A, 103B or independent copies of the computer-implemented agents 103A, 103B may comprise a set of shared input layers. That is, these neural networks may share a majority of their respective neural network parameters and include separately trained (multi-layer) “heads”. As such, it will be understood that the term “independent copy” is not limited to multiple instances, but may include querying the same instance with different contexts.

Generating the first protocol 105A output may comprise determining a single query input based on the first and second query inputs and setting the first protocol 105A output based on whether the probability for the logical step is greater than the combined single query input. For example, the single query input may be based on a combination of the first query input and the second query input. For example, for a first query input zₜ^{A} and a second query input zₜ^{B}, the single query input may be given by zₜ=zₜ^{A}+zₜ^{B} mod d+1, where d is the number of values in the set that the first and second query inputs may be sampled from. In an example implementation, the first computer-implemented agent 103A may set the probabilistic agent output 107 to a predetermined value (e.g. 1) if the probability of generating the single query input (e.g. zₜ/d) is less than or equal to the probability for the logical step. To obtain a first query input from an independent copy of the second computer-implemented agent 103B, the first computer-implemented agent 103A may query the independent copy of the second computer-implemented agent 103B for a random integer value sampled uniformly from {0, . . . , d}. Similarly, to obtain a second query input from an independent copy of the first computer-implemented agent 103A, the second computer-implemented agent 103B may query the independent copy of the first computer-implemented agent 103A for a random integer value sampled uniformly from {0, . . . , d}.

In FIG. 2 block 205 the second computer-implemented agent 103B determines whether the first computer-implemented agent 103A has generated the probabilistic agent output 107 in accordance with the first protocol 105A for each of the successive ones of the logical steps. In FIG. 2 block 205 the second computer-implemented agent 103B, when acting in accordance with the second protocol 105B and responsive to determining that the first computer-implemented agent 103A has not generated the probabilistic agent output 107 in accordance with the first protocol 105A, generates a warning 109 for each of the successive ones of the logical steps. FIG. 2-207 shows the scenario in which the second protocol 105B does not generate a warning 109.

Determining, by the second computer-implemented agent 103B, whether the first computer-implemented agent 103A has generated the probabilistic agent output 107 in accordance with the first protocol 105A may comprise sampling the probabilistic oracle in respect of the probabilistic logical step. For example, it may be assumed that in any of the logical steps, the second computer-implemented agent 103B may sample the probabilistic oracle to determine whether the first computer-implemented agent 103A has correctly generated the probabilistic agent output 107, i.e. whether the probabilistic agent output 107 correlates with probabilistic oracle values that would be output by a stochastic oracle 115 for the same input at the logical step. In one example implementation, the second computer-implemented agent 103B may obtain a plurality (for example r=24d² log 20T, or r=192d² log 100) of samples conditioned on y_{I(t)}=a_{I(t)} (i.e. conditioned on the input used by the first computer-implemented agent 103A to generate the probabilistic agent output 107 for the logical step) and compute the sample mean to determine whether the probabilistic agent output 107 is properly correlated with the probabilistic oracle value.

FIG. 2, at block 211 the computer-implemented method comprises a verification protocol 111. The verification protocol 111 may be performed by another computer-implemented agent, which may be referred to as a verifier. The verifier may not require, and may not be provided with, the same computational resources (such as computer, memory, storage, etc.) as the first and second computer-implemented agents 103A, 103B. For example, the first and second computer-implemented agents 103A, 103B may by polynomial in n (the length of the input) and the verifier may be linear in/(the length of each oracle query) and linear (or sub-linear) in n. The verifier may be a machine-learned model trained on data indicating human judgements. The data indicating human judgements may be sparse, for example, in comparison to data on which the first and/or second computer-implemented agents 103A, 103B are trained.

In FIG. 2 block 213 the verification protocol 111 generates a verification output 113 indicating that the agent output is valid if no warning 109 is generated 207 by the second computer-implemented agent 103B.

In FIG. 2 block 215 the verification protocol 111 samples the stochastic oracle 115 in respect of the probabilistic logical step 115 if the second computer-implemented agent 103B generates 209 a warning 109 for one of the successive probabilistic logical steps 109.

Sampling the stochastic oracle 115 may comprise outputting one or more questions to one or more other agents. That is, the stochastic oracle 115 may be the one or more other agents. The one or more other agents may comprise one or more human agents. In this case the one or more questions may be output to the human agents e.g. on a display or as speech and a user interface may be provided to receive answers in reply to the questions.

The one or more agents may comprise one or more machine-learned models trained to model human judgement. Sampling the stochastic oracle 115 may comprise outputting one or more questions in natural language to one or more agents, the question relating to the logical step in the justification. By way of example only, sampling the stochastic oracle 115 may comprise outputting a question of the form “Will performance of this step result in completion of this action?” or “Do these pixels relate to an engine?” Where the one or more agents include machine-learned models trained to model human judgements, the machine-learned models may be trained on a relatively sparse dataset, e.g., in comparison to a dataset used to train the first and/or second computer-implemented agents 103A, 103B. Sampling the stochastic oracle 115 may comprise outputting a plurality of oracle queries and receiving a plurality of corresponding oracle answers. Determining a correlation of the sampled results with the probabilistic agent output 107 may comprise determining a sample mean of the results of sampling the stochastic oracle 115 and determining a correlation between the sample mean and the probabilistic agent output 107. In implementations, sampling the stochastic oracle 115 may comprise obtaining r=24d² log 18 samples of the stochastic oracle 115. The samples may be conditioned on y_{I(t)}=a_{I(t)}, that is conditioned on the bits of the agent output a_{I(t)} used by the first computer-implemented agent 103A to generate the corresponding probabilistic agent output 107.

In some implementations, sampling the stochastic oracle 115 may comprise obtaining one or more sensor values from sensors configured to sense properties of an environment. By way of example only, the sensor values may include, e.g., one or more of: images, object position data, and sensor data to capture observations as a mechanical agent interacts with an environment, for example sensor data from an image, distance, or position sensor or from an actuator. For example in the case that the agent output relates to controlling a robot, sampling the stochastic oracle 115 may include obtaining sensor data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the mechanical agent. The sensor values may be defined in 1, 2 or 3 dimensions, and may be absolute and/or relative values. The sensor values may also include, for example, sensed electronic signals such as motor current or a temperature signal; and/or image or video data for example from a camera or a LIDAR sensor, e.g., data from sensors of the mechanical agent or data from sensors that are located separately from the mechanical agent in the environment. The environment may be a real-world environment or may be a simulated environment. In implementations, sampling the stochastic oracle 115 may comprise obtaining one or more responses to, for example, API calls or search queries (e.g. to one or more search engines).

In FIG. 2, at blocks 217 and 219 the computer-implemented method comprises generating the verification output 113 having the first value when a correlation of the sampled results with the probabilistic agent output 107 meets a first correlation criteria. The first correlation criteria may be a correlation threshold. For example, meeting the correlation criteria may require the correlation being above a correlation threshold.

In FIG. 2, at blocks 217 and 221 the computer-implemented method comprises generating the second verification output 113 having the second value when the correlation of the sampled results with the probabilistic agent output 107 does not meet the first correlation criteria.

The verification output 113 taking the second value may be statistically correlated with the agent output 107 provided by the first computer-implemented agent 103A in response to the input not being valid for the input.

The verification output 113 taking the second value may indicate that the first computer-implemented agent 103A has not generated the agent output 107 in accordance with predefined requirements that are determinable, at least in part, by sampling the stochastic oracle 115. For example, in implementations, the input I may comprise an information request, i.e. a request for information, in particular a natural language question and a verification output 113 indicating that the agent output 107 is not valid may indicate that the agent output 107 does not correctly answer the question. In another example, the input I may indicate a problem to be solved or a task to be performed, e.g. a request for instructions to solve the problem or perform the task and a verification output 113 indicating that the agent output 107 is not valid may indicate that performance of instructions included in the agent output 107 will not solve the problem or perform the task. Conversely, the verification output 113 taking the first value may indicate that the agent output 107 solves or is a correct answer to a particular problem indicated by the input I. For example, the problem may relate to controlling a physical actuator to operate in a desired manner, for example by picking up an object. As another example, the problem may relate to determining whether the answer provided by the agent output 107 to a particular natural language question is correct. Other examples of problems are set out below.

The first computer-implemented agent 103A may generate and output the justification. A verification output 113 having the first value may indicate that the first computer-implemented agent 103A has acted in accordance with the first protocol 105A and that the second computer-implemented agent 103B has acted in accordance with the second protocol 105B. An indication that the agent output is invalid may indicate that the first computer-implemented agent 103A has not acted in accordance with the first protocol 105A.

The first computer-implemented agent 103A and/or the second computer-implemented agent 103B may have been trained or fine-tuned to generate the agent output in response to the input I. For example, the first computer-implemented agent 103A and/or the second computer-implemented agent 103B may have been trained on data relating to operation of a controller configured to control actions in a real-world environment to perform a task. For example, the controller may control the actions of a mechanical system, which may also be termed a mechanical agent, such as a robot or vehicle, or manufacturing actions of a manufacturing plant, and the search system may be configured to return search results that relate to the operation of the controller. Implementations of the described system may be used to provide a user interface for allowing a user to verify that an output 107 provided by the first computer-implemented agent 103A will cause the controller to operate in a desired manner given the input I.

The verification output 113 may be one of a plurality of verification outputs 113 obtained by performing the verifying a plurality of times. That is, the first computer-implemented agent 103A, second computer-implemented agent 103B and verification protocol 111 may be repeated multiple times. In some examples, the first protocol 105A, second protocol 105B and verification protocol 111 may be repeated multiple times. A final verification output may be generated based on the plurality of verification outputs 113. For example, a majority outcome may be selected as the final verification output.

The techniques described herein may be used during training of a computer-implemented agent in order to reduce the incidence with which a computer-implemented agent outputs agent outputs that are invalid.

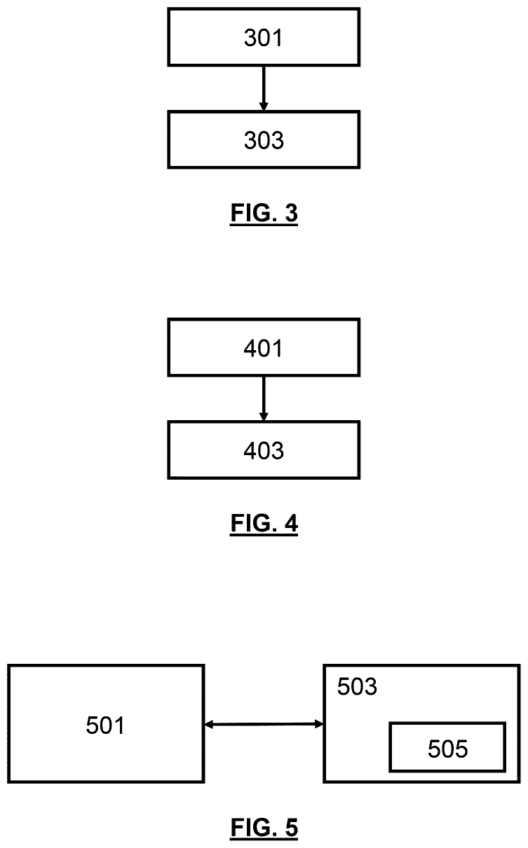

FIG. 3 shows an example method of training a computer-implemented agent. The computer-implemented agent trained may be a first computer-implemented agent 103A, a second computer-implemented agent 103B and/or any other computer implemented agent. In FIG. 3 block 301 the method of training a computer-implemented agent comprises performing, during training of the computer-implemented agent the method of verifying described above. For example, the verifying in FIG. 3 block 301 may be the verifying performed by one or more entities of the system shown in FIG. 1 and/or according to the method shown in FIG. 2. In FIG. 3, block 303 the method of training a computer-implemented agent comprises updating parameters of the computer-implemented agent based on a loss function comprising one or more terms configured to penalise an agent outputs that result in a verification output 113 indicating that the agent output 107 is not valid. The techniques described herein may be implemented during a reinforcement learning technique to alter a reward obtained-e.g. to reduce a reward for invalid agent outputs. The training may be performed online, or offline using previously stored data. In general the reinforcement learning technique can train an action selection policy neural network, e.g. the first and/or second computer-implemented agent 103A, 103B, by iteratively adjusting neural network parameter values of the action selection policy neural network, by iteratively backpropagating gradients of a reinforcement learning objective function through the neural network. Generally, any appropriate reinforcement learning objective function may be used, e.g., one dependent on a squared Bellman error, e.g., modified to encourage generation of agent outputs that result in a verification output 113 having the first value. Where the first computer-implemented agent 103A is pre-trained and/or fine-tuned by the reinforcement learning technique a regularization term may be included to keep a distribution of the actions close to a distribution of the initial, pre-trained neural network.

The techniques described herein may also be used during inference. FIG. 4 shows an example computer-implemented method. In FIG. 4, block 401 the computer-implemented method comprises receiving, from a first computer-implemented agent 103A, a first agent output 107 responsive to an input I, the input I indicating one or more tasks to be performed. In FIG. 4, block 403 the computer-implemented method may include verifying, in accordance with the verification techniques described herein whether the first agent output 107 generated by the first computer-implemented agent 103A in response to the input I is valid for the input I. For example, the verifying in FIG. 4 block 403 may be the verifying performed by one or more entities of the system shown in FIG. 1 and/or according to the method shown in FIG. 2. Verifying that the agent output 107 is valid may mean that a verification output 113 takes the first value-i.e., the verification output 113 is statistically correlated with an agent output provided by a first computer-implemented agent 103A in response to the input being valid. The determination as to whether the first agent output 107 is valid may be used to determine whether to use the first agent output 107. For example, in response to verifying that the first agent output 107 is valid, the method may include causing the task to be performed in accordance with the first agent output 107. The task may be any task as described herein, for example outputting instructions configured to cause a real-world agent to perform one or more actions to complete a task. Causing the task to be performed may comprise, for example, providing the first agent output to a controller configured to control a mechanical agent to perform a task in the real-world.

In response to determining that the first agent output 107 is not valid the method may obtain a second agent output responsive to the input I. The second agent output may be obtained from the first computer-implemented agent 103A and/or another computer-implemented agent. That is, the determination that the output is not valid may be used to try to obtain a further agent output that is valid. Obtaining of the second agent output may be conditioned on the invalidity of the first agent output.

In an aspect, there is described a method of verifying an output of a machine learned model, comprising receiving a first output 107 from a first computer-implemented agent 103A in response to processing an input I. The first output 107 indicates a plurality of positions and a value for at least one of the plurality of positions. A second output 109 is received from a second computer-implemented agent 103B configured to process the first output to indicate that an error is present in at least one of a subset of the plurality of positions of the first output. The first output 107 and the second output 109 are provided as input to a computer-implemented verifier 211 configured to evaluate the indication that an error is present and to output 113 an indication of whether the first output 107 is correct. The second computer-implemented agent 103B may be configured to process the first input 107 to generate a third output and to determine an error in the first output by comparing the first output and the third output.

In one aspect, one or more computer storage media store instructions that when executed by one or more computers cause the one or more computers to perform the operations of any of the methods described herein. FIG. 5 shows an example system. In one aspect the system comprises one or more computers 501 and one or more storage devices 503 communicatively coupled to the one or more computers 501, wherein the one or more storage devices 503 store instructions 505 that, when executed by the one or more computers 501, cause the one or more computers 501 to perform operations of any method described herein. Whilst the system in FIG. 5 shows one computer 501 communicatively coupled to one storage device 503, the skilled person would appreciate that the system may comprise one or more computers 501 communicatively coupled to one or more storage devices 503.

As described above, techniques described herein may be used to examine agent outputs from agents that are configured to generate instructions for performing actions in an environment. The techniques described herein may therefore be used in methods that operate in or on an environment.

In some implementations the environment is a real-world environment and the method (or a corresponding system) is used for diagnosing a fault in a mechanical system operating in the real world environment. That is, input I may be a request for a diagnosis and the agent output 107 may be a diagnosis. Then sampling 215 the oracle 115 may comprise obtaining from one or more sensors, e.g. as described above, one or more observations of the mechanical system (which here includes observations of the operation of mechanical system). For example the input I may comprise a general question such as “Is the system working correctly?” or “What is wrong with the system?” or a specific request such as “Is there a fault with component X?”. The ability to generate a verification output 113 for the agent output facilitates verifying that a particular fault diagnosis is correct.

As another example, the environment can be a computer security monitoring environment, e.g., the system can be deployed as part of a system that monitors the security of one or more computers. For example, the environment may be a computer network security monitoring environment, and the system can be deployed as part of a system that monitors the security of one or more computers on a computer network, e.g. a wireless network, a cellular network, a local area network and/or the internet. As another example, the environment may alternatively or additionally be a computer system security monitoring environment and the system can be deployed as part of a system that monitors the system for the presence of computer viruses and/or an unresolved software vulnerability, e.g. a zero-day exploit. A software vulnerability may be resolved by updating the software (e.g. patching) and/or removing (e.g. uninstalling) the software from the computer system. In these examples, the input I can query whether a computer security incident has been resolved (e.g., “has the incident been resolved?”) or how to resolve the incident. In this case example, sampling 215 the oracle 115 may comprise obtaining relevant statements from system logs, i.e., that are relevant to the logical step of the justification. A computer security incident can be, e.g., a data breach, an unauthorized log-in or other access of a secured system, a detection of a computer virus or detection of a software vulnerability. The incident can be “resolved” when the underlying incident is no longer a threat to the security of the computer system e.g., the computer virus has been removed, the access to the secured system has been removed, the data breach has been mitigated, or the software having the vulnerability has been updated or removed.

Sampling 215 the oracle 115 may include obtaining one or more of: code snippets from the software code, system logs, program logs, or other artifacts that should be left on the computer by running the program, or verification rules that represent requirements for the execution of the software program, or natural language statements describing the computer system on which the software executes.

In some implementations sampling 215 the oracle 115 may comprise obtaining, from system logs, data characterizing the computer network, or both, or from other data as described above, one or more observations of the computer network (which here includes computers on the network).

As another example, the environment can be a software generation, testing or evaluation environment, e.g., the system can be deployed as part of a system that generates software, which tests software before deployment or that evaluates already-deployed software to identify bugs. In these examples, when the system generates software, the input can indicate a task that the software should perform and the agent output can be one or more instructions to perform the task. Sampling 215 the oracle can include executing software instructions, e.g., isolated instructions, to determine an effect. When the system tests software before deployment, the input can ask whether the software will execute as intended, and sampling 215 the oracle can include obtaining code snippets from the software code. The verification output 113 can indicates whether the code will execute as intended. When the system monitors the execution of code after deployment, the input can ask whether a software program, or a portion of a software program, has executed as intended. Querying the oracle can include obtaining code snippets from the software code, system logs, program logs, or other artifacts that should be left on the computer by running the program, or verification rules that represent requirements for the execution of the software program, or natural language statements describing the computer system on which the software executes.

As another example, the environment can be an educational environment, e.g., the system can be deployed as part of an education software program that assists a user in learning or practicing one or more corresponding skills. In these examples, the input I can include a request for actions for a user or for instructions to control equipment in the educational environment. Sampling 215 the oracle 115 may include outputting queries to one or more human users, who may be domain experts for the corresponding skill.

As another example, the environment can be an information retrieval environment, e.g., the system can be deployed as part of a search engine or other software that allows a user to search for information in a corpus of documents, e.g., the Internet or another electronic document corpus. In these examples, the input I can be any input indicating a question, such as a natural language question, image data on which to perform an image search or audio data on which to perform an audio search. The agent output 107 can include, for example, relevant statements or extracts from the corpus of documents, e.g. as identified by searching the corpus using conventional information retrieval techniques. Sampling 215 the oracle may comprise

In some further applications the method, or a corresponding system, is used for control of a task in a real-world environment. That is, the input may relate to the task, e.g. it may comprise a request to perform the task, and the agent output may be used to control e.g. a mechanical system (which may be referred to as a mechanical agent), or a computer system for performing the task.

As one example, the input I may comprise a high level request, e.g. from a human, to perform a task, e.g., “How would you put the empty bottle in the bin?”, “Bring me a glass of water”, or Can you put the vacuum cleaner in the cupboard? ”. The agent output 107 may define one or more steps of the task, which may then be interpreted by the mechanical system, more specifically a control system of the mechanical system, to perform the step of the task. For example such a control system may convert the agent output 107 into a series of primitive actions to be performed by the mechanical system to perform the step of the task.

A mechanical system, hereafter also termed the mechanical agent, may include one or more sensors that capture observations of the environment, e.g., at specified time intervals, as the mechanical agent navigates through the environment or attempts to perform a task in the environment. Sampling 215 the oracle 115 may include sampling observations captured by the one or more sensors.

For example, the observations may include, e.g., one or more of: images, object position data, and sensor data to capture observations as the mechanical agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the mechanical agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the mechanical agent or data from sensors that are located separately from the mechanical agent in the environment.

The mechanical agent may be associated with a control system that generates control signals for controlling the mechanical agent using the observations generated by the sensors. In particular, the control system may generate control signals that cause the mechanical agent to follow a planned trajectory through the environment by first determining an appropriate action for the mechanical agent to perform, e.g., as part of performing a specified task, e.g., navigating to a particular location, identifying a particular object, moving a particular object to a given location, manipulating a particular object in some way, and so on, and then generating control signals that cause the mechanical agent to perform the action.

Such a control system can be deployed on-board the mechanical agent or can be deployed remotely from the mechanical agent and can transmit the control signals to the mechanical agent over a data communication network.

The control signals can be control inputs to control the mechanical agent. For example, when the mechanical agent is a robot the control signals can be, e.g., torques for the joints of the robot or higher-level control commands. As another example, when the mechanical agent is an autonomous or semi-autonomous land, air, sea vehicle, the control signals can include actions to control navigation, e.g., steering, and movement of the vehicle, e.g., braking and/or acceleration of the vehicle. For example, the control signals can be, e.g., torques to the control surface or other control elements, e.g., steering control elements of the vehicle, or higher-level control commands.

In other words, the control signals can include, for example, position, velocity, or force/torque/acceleration data for one or more joints of a robot or of parts of another mechanical agent (system).

In these examples, like the control system, software to implement a method as described herein (“ system software”) can be deployed on-board the mechanical agent or can be deployed remotely from the mechanical agent.

In these implementations, the system software may be used to provide an additional layer of control on top of the control system and the system software or another component can determine whether an output intended to control the mechanical agent is valid. The determination may be used to cause the mechanical agent to implement the output or to disregard the output.

In some implementations, the mechanical agent control system is an autonomous or semi-autonomous control system, e.g., that autonomously or semi-autonomously controls navigation or other actions of the mechanical agent, e.g. vehicle. Also or instead the mechanical agent control system may have an interface to receive control commands, e.g., from a human operator.

In these applications the described system software may be used to provide an additional layer of control, e.g., for safety purposes. For example, the described system software may be used to determine whether an agent output meets a safety criteria and to determine whether to act on the agent output in dependence on whether the safety criteria is met. For example the described system software may be used to inhibit control of the mechanical agent in a way that could be dangerous or contrary to one or more rules or preferences that the first computer-implement agent is intended to follow and which are determinable by, at least in part, sampling 215 the oracle 115. As one example, such rules or preferences (preference scores) may include rules/preferences relating to permitted movement of a vehicle, such as traffic rules, or of a robot, e.g. related to permitted (or forbidden) or preferable rules relating to safe movements or types of task. Such rules/preferences may include rules/preferences relating to decisions to be made to ensure safe behavior of the mechanical agent, e.g., to inhibit damage to the mechanical agent or to a human.

In some other implementations, the environment is a real-world environment that includes a manufacturing plant, e.g., a manufacturing plant for manufacturing a product, such as a chemical, biological, or mechanical product, or a food product. As used herein “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines for processing solid or other materials. The manufacturing units are configured such that an intermediate version or component of the product is moveable between the manufacturing units during manufacture of the product, e.g., via pipes or mechanical conveyance. In implementations the system is used for controlling one or more of the manufacturing units or for controlling movement of the intermediate version or component of the product between the manufacturing units.

Thus, in these implementations, sampling 215 the oracle 115 may comprise obtaining, from one or more sensors, one or more observations of the manufacturing units or of the movement. The sensors may comprise any type of sensor monitoring the manufacturing units or the movement, e.g., sensors configured to sense mechanical movement or force, pressure, temperature; electrical conditions such as current, voltage, frequency, impedance; quantity, level, flow/movement rate or flow/movement path of one or more materials; physical or chemical conditions, e.g., a physical state, shape or configuration or a chemical state such as pH; configurations of the units such as the mechanical configuration of a unit, or valve configurations; image or video sensors to capture image or video observations of the manufacturing units or of the movement; or any other appropriate type of sensor

The input I may relate to an action that controls operation of one or more of the manufacturing units or that controls the movement. The agent output 107 may be used to control operation of one or more of the manufacturing units or to control the movement. For example the agent output 107 may include instructions used to control, e.g., minimize, energy or other resource use, or to control the manufacture to obtain a desired quality or characteristic of the product. For example the actions may include actions that control items of equipment of the plant or actions that change settings that affect the manufacturing units or the movement of the product or intermediates or components thereof, e.g., to adjust or turn on/off items of equipment or manufacturing processes.

In some implementations the manufacturing plant has a plant control system to control the manufacturing units or to control the movement. The input I may be generated by, e.g. in response to, receiving a control signal from the plant control system and generating an input indicating a request to perform a task based on the control signal. In a similar way to that previously described the plant control system may be autonomous, semi-autonomous, or human-controlled.

In a similar way to that previously described the system may implement rules or preferences, e.g., to control or limit energy or other resource allocation, or to ensure a target quality or characteristic of the product, or to constrain operation of the plant, e.g., of the manufacturing units, within safe bounds.

In some implementations the environment is the real-world environment of a service facility comprising a plurality of items of equipment, e.g. items of electrical equipment, e.g. electrical components, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment. Then, sampling 215 the oracle 115 can include obtaining observations of a state of the environment including any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open. The input I can relate to the operation of the facility, e.g., to adjust the operation one or more items of equipment (e.g. electrical components) to control, e.g. minimize, use of a resource, such as a task to control use of electrical power or water. For example, the input I can ask which components to turn on to decrease use of the resource, or whether it is safe to turn on or off a given component. The agent output 107 can include instructions on how to operate the items of equipment based on the generated response, e.g., by turning on or off one or more components.

In some implementations the environment is the real-world environment of a power generation facility e.g. a renewable power generation facility such as a solar farm or wind farm and the request can relate to how to control power generated by the facility, e.g. to control the delivery of electrical power to a power distribution grid, e.g. to meet demand or to reduce the risk of a mismatch between elements of the grid, or to maximize power generated by the facility.

In general sampling 215 the oracle 115 relating to a state of the environment may comprise obtaining any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid, e.g. air or water, flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

In each of the examples set out above, it will be appreciated that sampling the oracle may include outputting one or more questions to a human user, for example in natural language.

Values sampled from one or more sensors may be output together with the questions where the values are used to support the logical step of the justification. For example, where the justification relies on a temperature of a component being at a particular value, the value of the component may be obtained and output in the question to the one or more human agents providing the oracle answer.

It is surprising, but well-established, that large language model/language generation neural networks can perform tasks that they were not explicitly trained to perform. For example they can perform translation tasks (provided that the training corpus included words in different languages), arithmetic, and many other tasks. A language model neural network can be made to perform a particular task by providing a natural language description of the desired response as an input or “prompt”. The prompt may be a few-shot prompt where a few, e.g., 1 to 10, examples of a query and an example output are provided in the text prior to the actual query. Instead or in addition, a language model neural network may be “fine-tuned” to perform a particular task, by obtaining a pre-trained language model neural network trained on a large corpus of examples as previously described and then further training part of all of the language model neural network on a relatively small number of examples particular to the type of task that is to be performed. Thus, a trained language model neural network can perform control and diagnosis tasks of the type described.

Some implementations of the methods/systems described herein use large language model/language generation neural networks. Such a large language model/language generation neural network may have greater than 1 billion, 10 billion or 100 billion trainable/trained parameters. It may have been trained on greater than 10 billion, 100 billion or 1000 billion words or tokens representing words. As previously described, the different language model/language generation neural networks described herein may comprise different instances of the same language model/language generation neural network.

Certain novel aspects of the subject matter of this specification are set forth in the claims below, accompanied by further description in Appendix A.

The subject matter described in this specification can be implemented in particular embodiments so as to realize one or more of the following advantages.

There can be a significant computational burden in determining whether an agent output is valid, particularly where a complexity of the output provided by the agent is beyond human ability to thoroughly check. As machine learned models become more sophisticated, it is increasingly the case that such models have knowledge and/or abilities that a human user lacks.

The techniques described herein enable an agent output to be processed to provide an indication as to whether the agent output is valid. Complex and extensive computations, which may be described in natural language, can be verified by querying an oracle for only few, or even a single, step(s) of such a computation. This enables a user, for example a human user, to verify the output of the model in a computationally efficient manner. In particular, the verification techniques described herein provide a protocol for a doubly-efficient debate where a computer-implemented agent outputting a valid output can demonstrate validity in polynomial time, even when a “dishonest” computer-implemented agent is allowed unbounded computation. The approaches described above enable a computer-implemented agent to learn by “self-play”, that is by “talking to”, i.e. conducting a dialogue with, itself with very limited external feedback.

Where machine learned models are used to control real-world systems and processes, such as control of mechanical agents to perform mechanical tasks, incorrect or invalid outputs from the machine learned model can result in failure to correctly perform the task. This can lead to wasted resources, for example where consumables, energy and time are used during an unsuccessful attempt to perform the task, along with those used in remedial actions. Further, control of real-world agents may have safety consequences. For example, imprecise or erroneous control of autonomous vehicles or of industrial robots may cause damage to humans, animals or equipment. The techniques described herein therefore enable users to efficiently ensure that machine learned models are trained to generate valid outputs or to evaluate outputs before use to help to ensure that the task will be performed correctly and/or safely.

The ability to demonstrate a valid output with few or a single step allows for at least part of the verification to be performed by devices having limited computing resources such as processor and memory resources.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are correspond toed in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes correspond toed in the accompanying figures do not necessarily require the particular order shown, or sequential order, to achieve desirable results. In some cases, multitasking and parallel processing may be advantageous.

What is claimed is:

1. A computer-implemented method of generating for an input a corresponding verification output that takes a first value or a second value, where the verification output taking the first value is statistically correlated with an agent output provided by a first computer-implemented agent in response to the input being valid for the input and the verification output taking the second value is statistically correlated with the agent output provided by the first computer-implemented agent in response to the input not being valid for the input, the verifying comprising:
employing a second computer-implemented agent, at least one of the first and second computer-implemented agents acting according to respective ones of a first and second protocol to verify, for a justification composed of a set of logical steps comprising one or more probabilistic agent outputs, whether the one or more probabilistic agent outputs correlate with probabilistic oracle values that would be output by a stochastic oracle,
the first protocol comprising for each of successive ones of the set of logical steps, generating a corresponding probabilistic agent output which is statistically correlated with a corresponding probabilistic oracle value;
the second protocol comprising for each of the successive ones of the logical steps:
determining whether the first computer-implemented agent has generated the probabilistic agent output in accordance with the first protocol;
responsive to determining that the first computer-implemented agent has not generated the probabilistic agent output in accordance with the first protocol, generating a warning;
a verification protocol comprising:
if no warning is generated by the second computer-implemented agent, generating a verification output indicating that the probabilistic agent output is valid;
if the second computer-implemented agent generates a warning for one of the successive probabilistic logical steps:
sampling the stochastic oracle in respect of the probabilistic logical step;
generating the verification output having the first value when a correlation of the sampled results with the probabilistic agent output meets a first correlation criteria; and
generating the second verification output having the second value when the correlation of the sampled results with the probabilistic agent output does not meet the first correlation criteria.

2. The method of claim 1, wherein the first computer-implemented agent and the second computer-implemented agent are respective instances of the same computer-implemented agent.

3. The method of claim 1, wherein the sampling the stochastic oracle comprises:
outputting a plurality of oracle queries and receiving a plurality of corresponding oracle answers; and
determining a sample mean of the oracle answers; and
determining a correlation of the sampled results with the probabilistic agent output comprises determining a correlation between the sample mean and the probabilistic agent output.

4. The method of claim 1, wherein generating a probabilistic agent output which is statistically correlated with the corresponding probabilistic oracle value comprises outputting a probability for the logical step that is equal to a probability that would be generated by the stochastic oracle for the logical step.

5. The method of claim 1, wherein generating first protocol output comprises:
the first computer-implemented agent obtaining a first query input from an independent copy of the second computer-implemented agent; and
the second computer-implemented agent obtaining a second query input from an independent copy of the first computer-implemented agent.

6. The method of claim 5, wherein generating a probabilistic agent output which is statistically correlated with the corresponding probabilistic oracle value comprises outputting a probability for the logical step that is equal to a probability that would be generated by the stochastic oracle for the logical step;
wherein generating the first protocol output comprises determining a single query input based on the first and second query inputs; and
setting the first protocol output based on whether the probability for the logical step is greater than the combined single query input.

7. The method of claim 5, wherein for a logical step t the probability for the logical step is given by
$${\hat{p}}_{t} = \frac{{\hat{c}}_{t}}{d} ,$$
where ĉₜ={0, . . . , d}, d is a positive integer;
wherein the first computer-implemented agent obtaining a first query input from an independent copy of the second computer-implemented agent comprises querying the independent copy of the second computer-implemented agent for a random integer value sampled uniformly from {0, . . . , d}; and
wherein the second computer-implemented agent obtaining a second query input from an independent copy of the first computer-implemented agent comprises querying the independent copy of the first computer-implemented agent for a random integer value sampled uniformly from {0, . . . , d}.

8. The method of claim 1, wherein determining, by the second computer-implemented agent, whether the first computer-implemented agent has generated the probabilistic agent output in accordance with the first protocol comprises sampling the stochastic oracle in respect of the probabilistic logical step.

9. The method of claim 1, wherein the first and second computer-implemented agents are sequence models.

10. The method of claim 1, wherein the first and second computer-implemented agents are multi-modal sequence models.

11. The method of claim 1, wherein the verification protocol is performed by a verifier that is computationally limited compared to the first and second computer-implemented agents.

12. The method of claim 1, wherein the stochastic oracle comprises one or more human agents.

13. The method of claim 1, wherein the stochastic oracle comprises one or more sensors measuring a real-world environment.

14. The method of claim 1, wherein the input indicates a security breach in a computing device or computer-network;
the agent output comprises computer program code for execution by the device or computer network; and
the verification output having the first value indicates that the output is configured to cause one or more computers to perform one or more actions configured to address the security breach.

15. The method claim 1, wherein the input comprises input data derived from one or more sensors, each sensor input indicating one or more properties of one or more physical objects in a real-word environment, the input further comprising a request to output one or more instructions to complete a task including an action on or using the one or more physical objects;
the agent output comprises one or more instructions for execution by a real-world agent interacting with the environment; and
the verification output having the first value indicates that execution of the one or more instructions by the real-world agent will result in completion of the action on or using the one or more physical objects.

16. The method of claim 15, further comprising selectively controlling the real-world agent to perform action when the verification output has the first value and not controlling the real-world agent to perform the action when the verification output has the second value.

17. The method of any one of claims 15, wherein the verification output having the first value indicates that completion of the action meets a safety criteria.

18. The method of claim 1, wherein the verification output is one of a plurality of verification outputs obtained by performing the verifying a plurality of times, and the method further comprises generating a final verification output based on the plurality of verification outputs.

19. One or more computer storage media storing instructions that when executed by one or more computers cause the one or more computers to perform a method for generating for an input a corresponding verification output that takes a first value or a second value, where the verification output taking the first value is statistically correlated with an agent output provided by a first computer-implemented agent in response to the input being valid for the input and the verification output taking the second value is statistically correlated with the agent output provided by the first computer-implemented agent in response to the input not being valid for the input, the verifying comprising:
execute a second computer-implemented agent, at least one of the first and second computer-implemented agents acting according to respective ones of a first and second protocol to verify, for a justification composed of a set of logical steps comprising one or more probabilistic agent outputs, whether the one or more probabilistic agent outputs correlate with probabilistic oracle values that would be output by a stochastic oracle,
the first protocol comprising for each of successive ones of the set of logical steps, generating a corresponding probabilistic agent output which is statistically correlated with a corresponding probabilistic oracle value;
the second protocol comprising for each of the successive ones of the logical steps:
determining whether the first computer-implemented agent has generated the probabilistic agent output in accordance with the first protocol;
responsive to determining that the first computer-implemented agent has not generated the probabilistic agent output in accordance with the first protocol, generating a warning;
execute a verification protocol comprising:
if no warning is generated by the second computer-implemented agent, generating a verification output indicating that the probabilistic agent output is valid;
if the second computer-implemented agent generates a warning for one of the successive probabilistic logical steps:
sampling the stochastic oracle in respect of the probabilistic logical step;
generating the verification output having the first value when a correlation of the sampled results with the probabilistic agent output meets a first correlation criteria; and
generating the second verification output having the second value when the correlation of the sampled results with the probabilistic agent output does not meet the first correlation criteria.

20. A system comprising:
one or more computers; and
one or more storage devices communicatively coupled to the one or more computers, wherein the one or more storage devices store instructions that, when executed by the one or more computers, cause the one or more computers to perform a method for generating for an input a corresponding verification output that takes a first value or a second value, where the verification output taking the first value is statistically correlated with an agent output provided by a first computer-implemented agent in response to the input being valid for the input and the verification output taking the second value is statistically correlated with the agent output provided by the first computer-implemented agent in response to the input not being valid for the input, the verifying comprising:
providing a second computer-implemented agent, at least one of the first and second computer-implemented agents acting according to respective ones of a first and second protocol to verify, for a justification composed of a set of logical steps comprising one or more probabilistic agent outputs, whether the one or more probabilistic agent outputs correlate with probabilistic oracle values that would be output by a stochastic oracle,
the first protocol comprising for each of successive ones of the set of logical steps, generating a corresponding probabilistic agent output which is statistically correlated with a corresponding probabilistic oracle value;
the second protocol comprising for each of the successive ones of the logical steps:
determining whether the first computer-implemented agent has generated the probabilistic agent output in accordance with the first protocol;
responsive to determining that the first computer-implemented agent has not generated the probabilistic agent output in accordance with the first protocol, generating a warning;
a verification protocol comprising:
if no warning is generated by the second computer-implemented agent, generating a verification output indicating that the probabilistic agent output is valid;
if the second computer-implemented agent generates a warning for one of the successive probabilistic logical steps:
sampling the stochastic oracle in respect of the probabilistic logical step;
generating the verification output having the first value when a correlation of the sampled results with the probabilistic agent output meets a first correlation criteria; and
generating the second verification output having the second value when the correlation of the sampled results with the probabilistic agent output does not meet the first correlation criteria.
